(19) United States
(12) Patent Application Publication
(10) Pub. No.: US 2023/0046774 A1
(43) Pub. Date: Feb. 16, 2023

(54) CONNECTOR

(71) Applicant: JAPAN AVIATION ELECTRONICS INDUSTRY, LIMITED, Tokyo (JP)

(72) Inventor: Yohei YOKOYAMA, Tokyo (JP)

(73) Assignee: JAPAN AVIATION ELECTRONICS INDUSTRY, LIMITED, Tokyo (JP)

(21) Appl. No.: 17/865,474

(22) Filed: Jul. 15, 2022

(30) Foreign Application Priority Data
Aug. 16, 2021 (JP) 2021-132179

(51) Int. Cl. H01R 12/71; H01R 13/516; H01R 43/16; H01R 12/57

(52) U.S. Cl. CPC H01R 12/716; H01R 13/516; H01R 43/16; H01R 12/57

(57) ABSTRACT

A connector including an insulating housing, a plurality of terminals arrayed and held on the housing, and a conductive shell, wherein the housing is positioned within the shell in island form. The shell is formed of a single metal plate, and includes a peripheral wall surrounding the housing, bottom plates extending from lower ends of the peripheral wall on a side of mounting to the board to inside of the peripheral wall, and a pair of supporting pieces extending from the bottom plates and supporting the housing. The pair of supporting pieces are formed by being raised from the bottom plates so as to respectively conform to side surfaces of the housing that are opposite each other, and then being folded with their tips press-fit in the housing. The peripheral wall is of a single-ply structure of the metal plate without a seam throughout a periphery thereof.

### TECHNICAL FIELD

The present invention relates to a connector that is used by being mounted on a board as a board-to-board connector, for example.

### BACKGROUND ART

Japanese Patent Application Laid Open No. 2021-89829 (hereinafter referred to as Patent Literature 1) describes a board-to-board connector. FIG. 1 shows a first connector 10 as a component of the board-to-board connector described in Patent Literature 1, and FIG. 2 shows a second connector 20 as a component of the board-to-board connector.

The first connector 10 is formed of a first insulator 11, multiple first contacts 12 arrayed and held on the first insulator 11, and a conductive first shell 13. FIG. 3A shows the first shell 13 and FIG. 3B shows a state in which the first shell 13 has been removed from the first connector 10.

The first insulator 11 has a bottom plate portion 11a and a pair of side walls 11b. A central protruding portion 11c is formed on an upper surface of the bottom plate portion 11a so as to protrude, and lateral protruding portions 11d are further formed on the opposite sides across the central protruding portion 11c so as to protrude. Recessed portions 11e, 11f are formed on the opposing side surfaces of the central protruding portion 11c and the lateral protruding portions 11d, respectively, and each first contact 12 straddles these recessed portions 11e and 11f and fixedly held on the first insulator 11.

The first shell 13 in the form of a square frame is formed by folding of a metal plate, having outer wall portions 14 positioned on the opposing two sides as the longer sides of the square, respectively, and outer wall portions 15 positioned on the other opposing two sides as the shorter sides of the square, respectively. The first shell 13 further has a pair of inner wall portions 16 and a pair of inner wall portions 17 which are folded back inward from the outer wall portions 14, 15, respectively, and positioned inside the outer wall portions 14, 15, respectively. The neighboring outer wall portions 14 and 15 are coupled at an upper end by a coupling portion 18. Projections 17a are formed at the ends of the inner wall portions 17 in a side direction so as to protrude, and an arm portion 19 is formed in an extending manner in a central portion of a lower end of each inner wall portion 17.

Attachment of the first shell 13 is done by placing the first shell 13 over the first insulator 11 having the first contacts 12 held thereon and pushing in the first shell 13, press-fitting the inner wall portions 17 having the projections 17a into recessed portions 11g in the inner surfaces of the side walls 11b of the first insulator 11, and press-fitting tip portions 19a of the arm portions 19 into holes 11i in step portions 11h, which are at the opposite ends of the central protruding portion 11c.

The second connector 20 is formed of a second insulator 21, multiple second contacts 22 arrayed and held on the second insulator 21, and a conductive second shell 23. The second insulator 21 has a pair of retaining walls 21a. The second contacts 22 are insert-molded on the second insulator 21 and arrayed and held on the respective retaining walls 21a.

The second shell 23 in the form of a square frame is formed by folding of a metal plate, having outer wall portions 24 positioned on the opposing two sides as the longer sides of the square, respectively, outer wall portions 25 positioned on the opposing two sides as the shorter sides of the square, respectively, and coupling portions 26 coupling upper ends of the outer wall portions 24 and 25. Attachment of the second shell 23 is done by placing the second shell 23 over the second insulator 21 having the second contacts 22 held thereon and pushing in the second shell 23, as with the first shell 13 of the first connector 10.

The first connector 10 and the second connector 20 are mounted on the opposing surfaces of boards which are placed opposite each other, and connected with each other. FIG. 4 shows the first connector 10 and the second connector 20 in a connected state, where the boards are not illustrated. The second connector 20 is fitted into the first shell 13 of the first connector 10 in the form of a square frame and connected with the first connector 10.

For such connectors mounted on boards as board-to-board connectors, measures against EMI are an increasingly important issue with more compact electronic devices being used, higher packaging density, and higher frequencies of electrical signals.

With the conventional board-to-board connector consisting of the first connector 10 and the second connector 20 described above, the first connector 10 and the second connector 20 have their respective first shell 13 and second shell 23 which are conductive such that the first shell 13 and the second shell 23 each provide electromagnetic shielding; however, both the first shell 13 and the second shell 23 defining the outer enclosures of the first connector 10 and the second connector 20 are of a shape with portions of the outer walls missing at the corners of the square and electromagnetic leakage occurs from these missing portions of the outer walls. Thus, their shielding effect cannot be said to be sufficient.

### BRIEF SUMMARY OF THE INVENTION

In view of this issue, an object of the present invention is to provide a connector having good shielding performance.

Technical matters described herein are not intended to explicitly or implicitly limit the invention as recited in the claims and further are not a statement of possibility of permitting such a limitation by persons other than those who benefit from this invention (for example, the applicant and a right holder), but are described merely for facilitating understanding the gist of the present invention. Overview of the present invention from other aspects can be understood from the claims as of the filing of the present application, for example.

The conductive shell of the connector has an enclosing wall (also called a “peripheral wall” below) in the form of a frame without a seam. The enclosing wall surrounds four sides of the insulating housing that holds terminals therein.

### Effects of the Invention

According to the present invention, the peripheral wall of the conductive shell surrounding the housing having terminals held thereon is of a structure without a seam throughout its periphery. Hence, good shielding performance can be achieved.

### BRIEF DESCRIPTION OF THE DRAWINGS

FIG. 1 is a perspective view showing a first connector for a conventional board-to-board connector.

FIG. 2 is a perspective view showing a second connector for the conventional board-to-board connector.

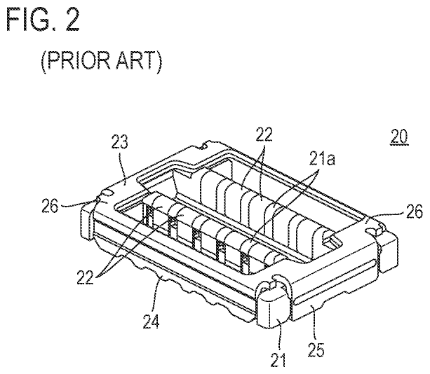

FIG. 3A is a perspective view showing a first shell in FIG. 1.

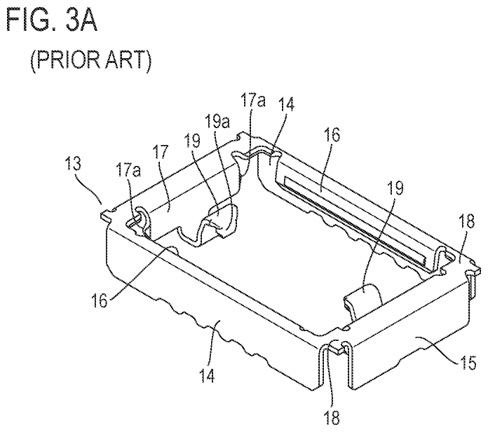

FIG. 3B is a perspective view showing a first insulator having first contacts held thereon from FIG. 1.

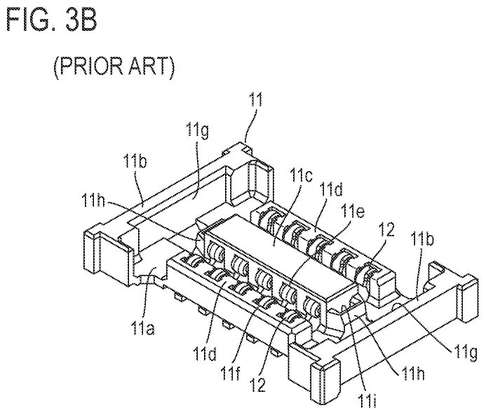

FIG. 4 is a perspective view showing the first connector shown in FIG. 1 and the second connector shown in FIG. 2 in a connected state.

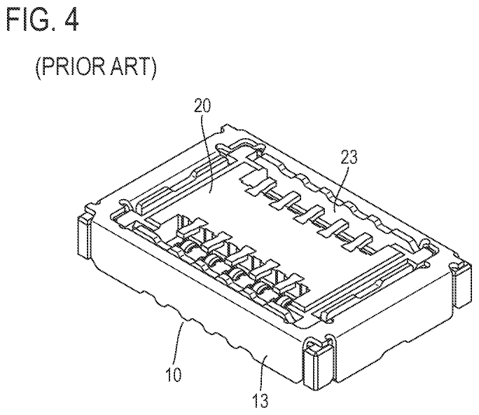

FIG. 5A is a perspective view of a connector according to an embodiment as seen from above.

FIG. 5B is a perspective view of the connector shown in FIG. 5A as seen from below.

FIG. 6A is a perspective view of a housing shown in FIG. 5A having terminals held thereon as seen from above.

FIG. 6B is a perspective view of the housing shown in FIG. 6A having terminals held thereon as seen from below.

FIG. 7A is a perspective view of a shell shown in FIG. 5A as seen from above.

FIG. 7B is a perspective view of the shell shown in FIG. 7A as seen from below.

FIG. 8 is a perspective view showing a mating connector to be fitted with the connector shown in FIG. 5A.

FIG. 9 is a perspective view showing the connector shown in FIG. 5A and the mating connector shown in FIG. 8 in a connected state.

### LIST OF REFERENCE NUMERALS

10: first connector
11: first insulator
11a: bottom plate portion
11b: side wall
11c: central protruding portion
11d: lateral protruding portion
11e: recessed portion
11f: recessed portion
11g: recessed portion
11h: step portion
11i: hole
12: first contact
13: first shell
14: outer wall portion
15: outer wall portion
16: inner wall portion
17: inner wall portion
17a: projection
18: coupling portion
19: arm portion
19a: tip portion
20: second connector
21: second insulator
21a: retaining wall
22: second contact
23: second shell
24: outer wall portion
25: outer wall portion
26: coupling portion
30: housing
30a: upper surface
30b: lower surface
30c: side surface
30d: side surface
30e: side surface
30f: side surface
31: groove
32: recessed portion
33: recessed portion
34: hole
35: recessed portion
40: terminal
41: connecting portion
50: shell
51: peripheral wall
51a: bent portion
51b: lug
51c: lug
52: bottom plate
52a: notch
53: supporting piece
53a: raised portion
53b: extension portion
53c: tip portion
60: housing
70: terminal
80: shell
81: outer wall portion
82: outer wall portion
81a: lug
82a: extension portion
83: coupling portion
84: inner wall portion
100: connector
200: mating connector

### DETAILED DESCRIPTION

An embodiment is described with reference to drawings.

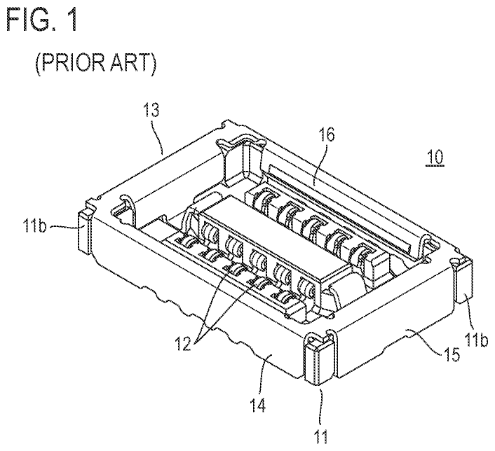

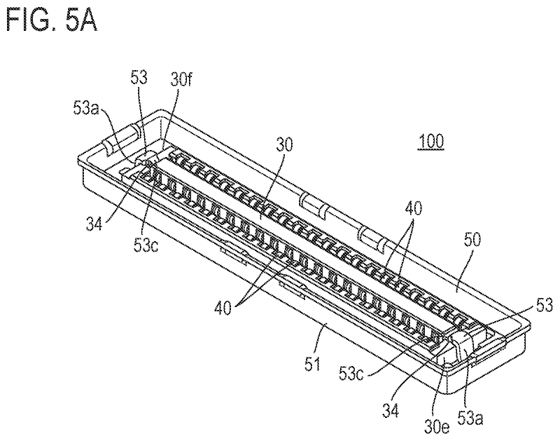

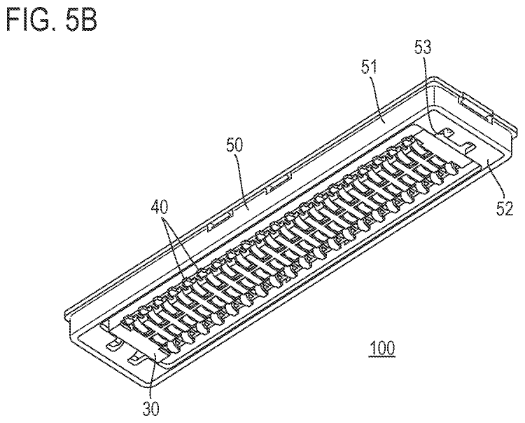

FIGS. 5A and 5B show an embodiment of a connector of the present invention, where a connector 100 is a connector for mounting on one board as a board-to-board connector, for example, and is a connector on the side to which the mating connector is fitted (a connector for receiving the mating connector), corresponding to the aforementioned first connector 10 shown in FIG. 1.

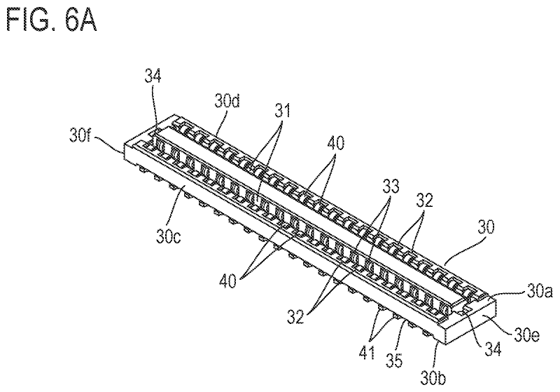

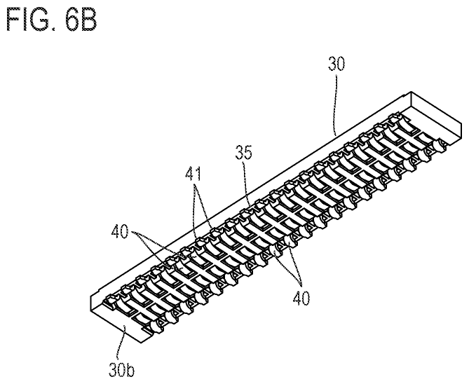

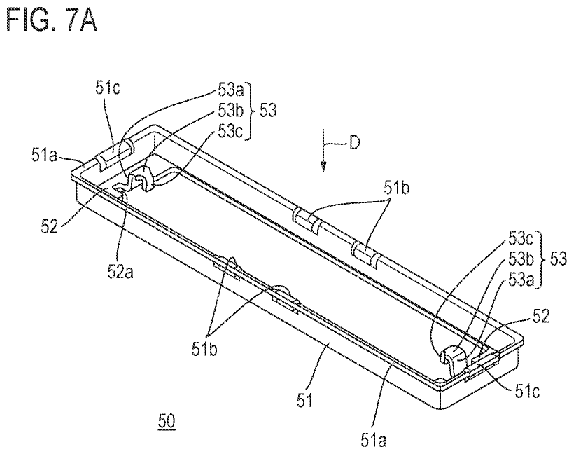

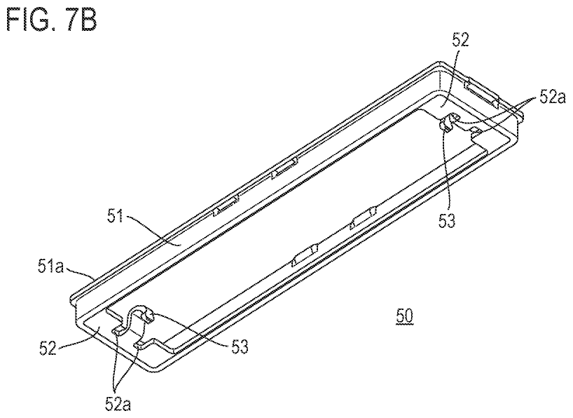

The connector 100 is formed of an insulating housing 30, multiple (forty in this example) terminals 40 arrayed and held on the housing 30, and a conductive shell 50. FIGS. 6A and 6B show a state in which the shell 50 has been removed from the connector 100, and FIGS. 7A and 7B show details of the shell 50.

The housing 30 is made of resin and in this example is in the shape of an elongated, flat substantially rectangular parallelepiped. The housing 30 has two elongated grooves 31 formed in parallel to each other and extending in a longitudinal direction except for longitudinal ends. In the longitudinal inner walls of these grooves 31 that are opposite each other, recessed portions 32, 33 are formed, respectively, being arrayed in the longitudinal direction at a predetermined pitch, where twenty pairs of the recessed portions 32, 33 formed opposite each other are present in each of the grooves 31. At the longitudinal ends of the housing 30, holes 34 positioned in the center of a width direction of the housing 30 are formed respectively in upper surfaces 30a of the housing 30.

The terminals 40 have been inserted from a lower surface 30b of the housing 30 and attached to the housing 30. Each terminal 40 straddles the recessed portions 32 and 33, where twenty terminals 40 are arranged in each groove 31 of the housing 30. A connecting portion 41 of each terminal 40 to be soldered to a pad on the board is positioned in a recessed portion 35 formed in the lower surface 30b of the housing 30, with the tips of the terminals 40 slightly protruding from side surfaces 30c, 30d of the housing 30, respectively.

The shell 50 is formed by processing of a single metal plate, having a peripheral wall 51 in the form of a rectangular frame, bottom plates 52 formed extending from lower ends of the peripheral wall 51 on the side of mounting to the board to inside of the peripheral wall 51, and a pair of supporting pieces 53 formed extending from the bottom plates 52.

The bottom plates 52 are positioned at longitudinal ends of the shell 50 and slightly block an opening formed by the peripheral wall 51. The pair of supporting pieces 53 are formed by being raised so as to face each other from the bottom plates 52, which are positioned at the longitudinal ends of the shell 50. Each supporting piece 53 is formed of a raised portion 53a, an extension portion 53b extending being folded from the raised portion 53a inwardly with respect to the opposite extension portion 53b, and a tip portion 53c extending being folded downward from the extension portion 53b. Each bottom plate 52 is provided with notches 52a positioned on the opposite sides of the supporting piece 53 in the width direction.

The peripheral wall 51 is of a single-ply structure of a metal plate which is continuous without a seam throughout the periphery, and a bent portion 51a formed by being bent outward is provided at an upper end throughout the periphery. Two lugs 51b protruding inward are formed respectively on the upper end side of the opposing two sides of the peripheral wall 51 representing the longer sides of the rectangle, while one lug 51c which also protrudes inward is formed respectively on the upper end side of the other opposing two sides representing the shorter sides of the rectangle.

The shell 50 structured as described above is formed by drawing a blank (flat plate) cut into a required shape and then performing bending of the supporting pieces 53 and processing for making lugs 51b, 51c stick out. In FIG. 7A, arrow D indicates the direction of drawing. The bottom plate 52 defines the bottom in the drawing process.

Attachment of the shell 50 to the housing 30 is done by pushing down the shell 50 from above the housing 30 having the terminals 40 held thereon, and press-fitting the tip portions 53c of the pair of supporting pieces 53 into the holes 34 of the housing 30. The housing 30 is supported by the pair of supporting pieces 53 and positioned within the shell 50 in island form, creating a structure in which its entire periphery is surrounded by the peripheral wall 51 of the shell 50, thus completing the connector 100 shown in FIGS. 5A and 5B. The raised portions 53a of the pair of supporting pieces 53 are positioned so as to respectively conform to side surfaces 30e, 30f of the housing 30 at the longitudinal ends (side surfaces of the housing 30 that are opposite each other), making a structure of sandwiching the housing 30.

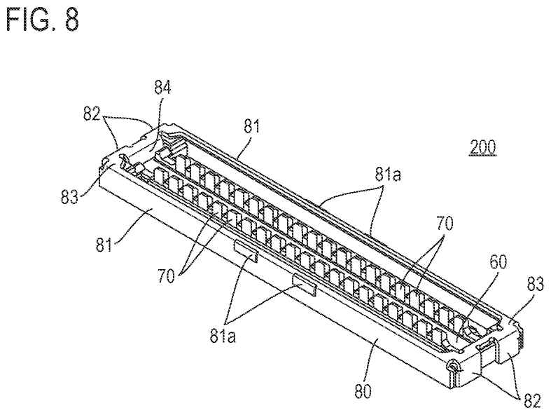

FIG. 8 shows a mating connector 200 which is connected with the connector 100 described above to constitute a board-to-board connector. In FIG. 8, reference numeral 60 indicates an insulating housing and 70 indicates a terminal. Reference numeral 80 indicates a conductive shell. The terminals 70 are insert-molded on the housing 60 and arranged in two rows, where there are twenty terminals per row, or forty terminals in total in the two rows.

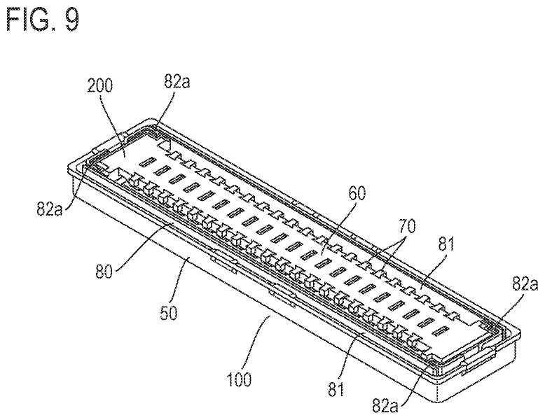

The shell 80 in the form of a rectangular frame is formed by folding of a metal plate in this example, and has outer wall portions 81 positioned on the opposing two sides as the longer sides of the rectangle, respectively, outer wall portions 82 positioned on the opposing two sides as the shorter sides of the rectangle, respectively, coupling portions 83 coupling upper ends of the outer wall portions 81 and 82, and inner wall portions 84 folded inward from the respective outer wall portions 82 and positioned inside the outer wall portions 82. Each outer wall portion 82 is split into two due to lack of a center of the side direction, and has extension portions 82a (see FIG. 9 discussed later) which extend being folded from the opposite ends of the side direction, and are positioned inside the outer wall portions 81, and overlap the outer wall portions 81.

Attachment of the shell 80 to the housing 60 is done by placing the shell 80 over the housing 60 having the terminals 70 held thereon and pushing in the shell 80. Two lugs 81a protruding outward are formed on each of the two outer wall portions 81 of the shell 80 on the upper end side.

FIG. 9 shows the connector 100 and the mating connector 200 in a connected state, where the boards on which the connector 100 and the mating connector 200 are mounted respectively are not illustrated. The mating connector 200 is structured to be fitted into the shell 50 of the connector 100 and connected with the connector 100.

While the structure of the connector 100 as an embodiment of the connector according to the present invention has been described and further the structure of the mating connector 200 and the state of connection with the mating connector 200 have been described, the structure of the connector 100 can provide the effects (1) and (2):

(1) Since the peripheral wall 51 of the shell 50 defining the outer enclosure of the connector 100 and responsible for electromagnetic shielding is structured such that a metal plate runs continuously throughout the periphery and there is no seam throughout the periphery, electromagnetic leakage or the like does not occur as in the conventional first connector 10 and hence good shielding performance can be obtained.

In addition, as the connector 100 is a connector into which the mating connector 200 is fitted and which receives the mating connector 200, the mating connector 200 is also enclosed by the peripheral wall 51 of the shell 50 when the mating connector 200 is connected. Accordingly, sufficient shielding performance can be achieved in a state of connection even if the shielding performance of the mating connector 200 is not sufficient, for example.

(2) The peripheral wall 51 of the shell 50 is formed of a single-ply metal plate unlike the conventional first connector 10 where two layers of metal plates are present inside and outside. Also, the housing 30 is not present in the portion where the peripheral wall 51 is positioned but the peripheral wall 51 is present alone, and the housing 30 is configured to be positioned within the shell 50 in island form. These aspects facilitate downsizing of the connector.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A connector configured to be mounted on a board, the connector comprising an insulating housing, terminals arrayed and held on the housing, and a conductive shell, wherein
the housing is positioned within the shell in island form,
the shell is formed of a single metal plate, and includes a peripheral wall surrounding the housing, bottom plates extending from lower ends of the peripheral wall on a side of mounting to the board to inside of the peripheral wall, and a pair of supporting pieces extending from the bottom plates and supporting the housing,
the pair of supporting pieces are formed by being raised from the bottom plates so as to respectively conform to side surfaces of the housing that are opposite each other, and then being folded with their tips press-fit in the housing, and
the peripheral wall is of a single-ply structure of the metal plate without a seam throughout a periphery thereof.

2. The connector according to claim 1, wherein
a bent portion formed by being bent outward is provided at an upper end of the peripheral wall throughout the periphery.
